(19) United States
(12) Patent Application Publication
(10) Pub. No.: US 2011/0227953 A1
(43) Pub. Date: Sep. 22, 2011

(54) Gray Scale Data Bit Allocation Processing Method Within a Light-Emitting Diode Driving Integrated Circuit Device

(76) Inventors: Shar-Ming LIN, Taipei (TW); Ching-Pao Chou, Taipei (TW)

(21) Appl. No.: 12/189,173

(22) Filed: Aug. 10, 2008

(30) Foreign Application Priority Data
Jan. 30, 2008 (TW) 097103588

(51) Int. Cl. G09G 5/10

(52) U.S. Cl. 345/690

(57) ABSTRACT

The present invention provides a gray scale data bit allocation processing method within a light-emitting diode driving integrated circuit device, and includes the following steps: 1. Dividing original gray scale data into high-bit data and low-bit data within a light-emitting diode driving integrated circuit device; 2. Converting the low-bit data into multi-bit stack data having fewer bits; 3. Adding the high-bit data to the stack data to form display data; 4. Converting each of the original gray scale data into multiple display data having less quantity of data; 5. Displaying a picture using the display data with a higher refresh rate. Accordingly, the present invention is provided with the effectiveness to use less quantity of data to achieve more gray, as well as improving the picture refresh rate of the high-bit portions.

### BACKGROUND OF THE INVENTION

(a) Field of the Invention

The present invention relates to a gray scale data bit allocation processing method within a light-emitting diode driving integrated circuit device, and more particularly to a dividing and recombining method used to reduce a quantity of data, and adjustment of weight values and refresh rate is employed to obtain a display gray scale identical to the original gray scale data. After undergoing such a method of processing, the picture refresh rate of the high color scale portions can be increased, and the complete gray scale numbers can still be completed within the original time, thereby providing the present invention with both the effectiveness to use less quantity of data to achieve more gray scale numbers and increase the picture refresh rate of the high-bit portions. Moreover, the method of the present invention is applicable for use in various types of gray scale data bit allocation processing within light-emitting diode driving integrated circuit devices.

(b) Description of the Prior Art

A method for gray scale data bit processing of a light-emitting diode driving integrated circuit device of the prior art consists of processing bits, bit values and defined weight values of original gray scale data within a light-emitting diode driving integrated circuit device; an example of which is described as follows: Referring to FIG. 1, in which a 12-bit original gray scale data A comprises bits A1: 0-11; bit values A2: 1, 1, 0, 0, 1, 1, 0, 0, 1, 1, 0, 1; defined weight values A3: 1, 2, 4, 8, 16, 32, 64, 128, 256, 512, 1024, 2048; accordingly, weight value sum A4 of the 12-bit original gray scale data A is 2867. If a method is adopted whereby one original gray scale data is processed at a time, once an error of transmission occurs in the bit values A2, then the weight value sum A4 of the 12-bit original gray scale data will be affected. Moreover, the method is unable to use less quantity of data to achieve processing more gray scale numbers, and is unable to achieve the effectiveness to increase the picture refresh rate. Hence, in actual use, the prior art still does not meet user requirements.

### SUMMARY OF THE INVENTION

Hence, a primary objective of the present invention is to provide a gray scale data bit allocation processing method within a light-emitting diode driving integrated circuit device which uses less quantity of data to achieve more gray scale numbers, and enables improving the effectiveness to increase the picture refresh rate of high-bit portions and increase practicability.

In order to achieve the aforementioned objectives, the gray scale data bit allocation processing method within a light-emitting diode driving integrated circuit device of the present invention comprises the following steps: 1. Dividing original gray scale data into high-bit data and low-bit data within a light-emitting diode driving integrated circuit device; 2. Converting the low-bit data into multi-bit stack data having fewer bits; 3. Adding the high-bit data to the stack data to form display data; 4. Converting each of the original gray scale data into multiple display data having less quantity of data; 5. Displaying a picture using the display data with a higher refresh rate. Accordingly, the present invention is provided with the effectiveness to use less quantity of data to achieve more operational gray scale numbers and reduce probability for errors in bit transmission, as well as improving the picture refresh rate of the high-bit portions and increasing functionality.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of the prior art.

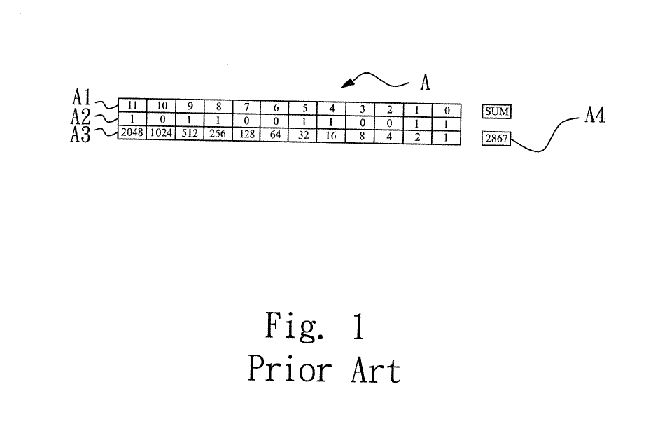

FIG. 2 is a schematic view depicting steps in the present invention.

FIG. 3 is a schematic view depicting use of the present invention.

### DETAILED DESCRIPTION OF THE PREFERRED EMBODIMENTS

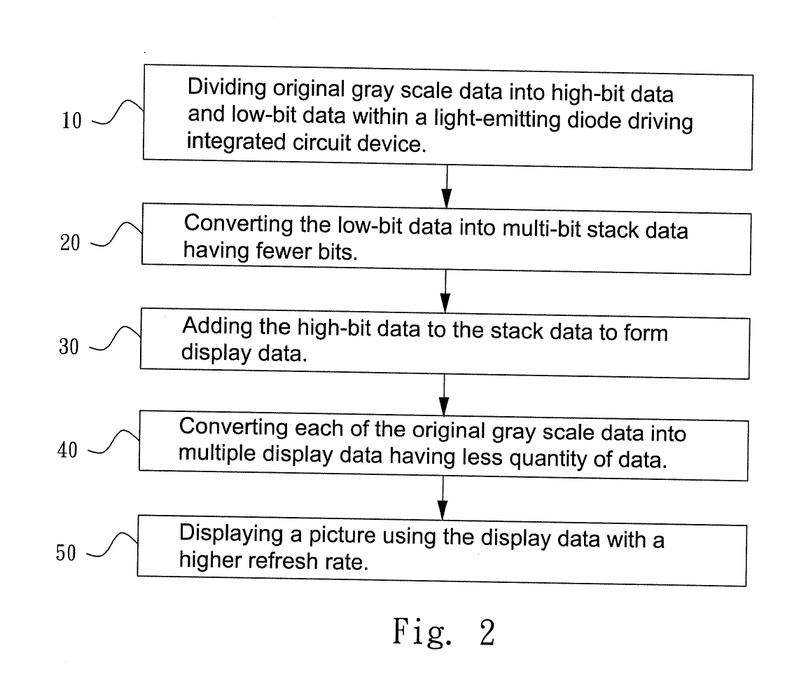

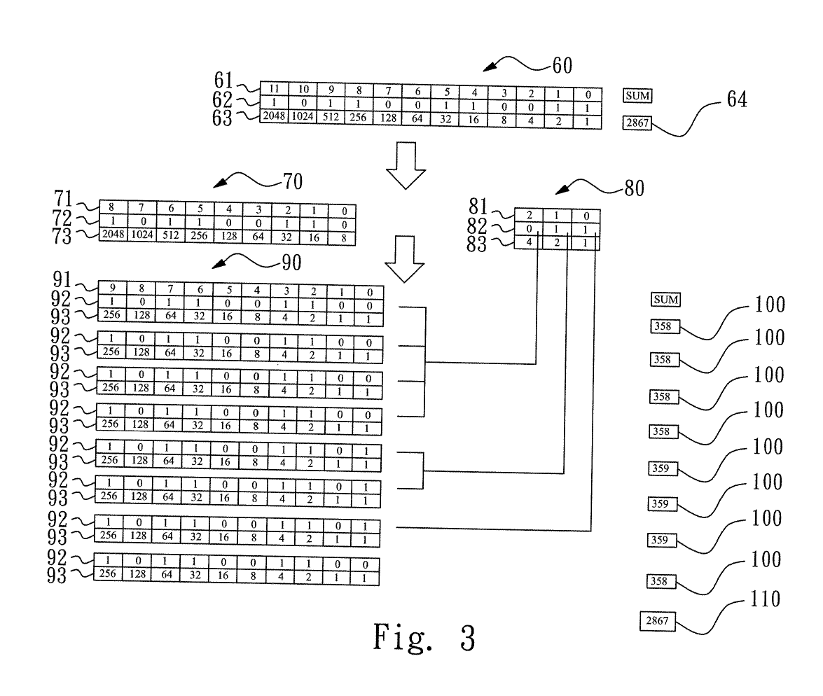

Referring to FIGS. 2 and 3, a gray scale data bit allocation processing method within a light-emitting diode driving integrated circuit device of the present invention comprises the following steps:

1. Dividing original gray scale data 60 into high-bit data 70 and low-bit data 80 within a light-emitting diode driving integrated circuit device (step 10).

2. Converting the low-bit data 80 into multi-bit stack data having fewer bits (step 20).

3. Adding the high-bit data 70 to the stack data to form display data (step 30).

4. Converting each of the original gray scale data 60 into multiple display data 90 having less quantity of data (step 40).

5. Displaying a picture using the display data 90 with a higher refresh rate (step 50).

Representative brightness defined weight values 63, 73, 83, 93 of each bit 61, 71, 81, 91 respectively in the light-emitting diode driving integrated circuit device are already set, and are restored to a weight value sum 64 of the original gray scale data 60 by repeated renewing.

Accordingly, the aforementioned steps constitute the gray scale data bit allocation processing method within a light-emitting diode driving integrated circuit device. Referring to FIGS. 2 and 3, the present invention is characterized in that the gray scale data bit allocation processing method within a light-emitting diode driving integrated circuit device divides the original gray scale data 60 into two portions including the high-bit data 70 and the low-bit data 80 by means of the light-emitting diode driving integrated circuit device, and the low-bit data 80 is converted into multi-bit stack data having fewer bits. Moreover, a raised refresh rate (refresh rate refers to the reciprocal of period (frequency), meaning of which is the completed number of cycles within a certain time, and the so-called one complete cycle refers to the time required to completely display the original gray scale data 60 one time, that is, the time spent by the light-emitting diode driving integrated circuit device to actuate and completely light up and shut off the LEDs (Light Emitting Diodes). Light and shade variation of the LEDs is controlled by bit data, number of which is called the gray scale number. The gray scale data is composed of a plurality of bits, the higher the gray scale number, the greater the number of bits required to compose the gray scale data. The ascribed weight value of each bit of the gray scale data entering the light-emitting diode driving integrated circuit device is different, and bit values 62, 72, 82, 92 are used to convert the defined weight values 63, 73, 83, 93 to obtain the displayable gray scale) is used to obtain the identical original gray scale representation, the complete gray scale still being completed within the original cycle, thus enabling increasing refresh rate of the high-bit portions (the standard gray scale data) several fold, and providing the present invention with the effectiveness to use less data to achieve more gray scale numbers; as well as enabling improving the picture refresh rate effectiveness of the high-bit portions and increasing practicability.

Referring to FIG. 3 (taking the 12-bit original gray scale data 60 as an example), when in use, the 12-bit original gray scale data 60 (bits 61: 0-11; bit values 62: 1, 1, 0, 0, 1, 1, 0, 0, 1, 1, 0, 1; the defined weight values 63: 1, 2, 4, 8, 16, 32, 64, 128, 256, 512, 1024, 2048) in the light-emitting diode driving integrated circuit device is first divided into two portions, including the 9-bit high-bit data 70 (bits 71: 0-8; bit values 72: 0, 1, 1, 0, 0, 1, 1, 0, 1; defined weight values 73: 8, 16, 32, 64, 128, 256, 512, 1024, 2048) and the 3-bit low-bit data 80 (bits 81: 0-2; bit values 82: 1, 1, 0; defined weight values 83: 1, 2, 4), then the 3-bit low-bit data 80 is converted into 1-bit stack data having fewer bits, after which the 9-bit high-bit data 70 is added to the 1-bit stack data to form the 10-bit display data 90. Finally, each of the 12-bit original gray scale data 60 is converted into the 10-bit display data 90 of fewer bits (bits 91: 0-9; corresponding bit values 92 of the eight groups of bits 1-9 are identical: 0, 1, 1, 0, 0, 1, 1, 0, 1, and the bit values 92 of the eight groups of the other bits 0 of the bits 91 are respectively: 0, 0, 0, 0, 1, 1, 0; corresponding defined weight values 93 of the eight groups of bits 1-9 of the bits 91 are identical: 1, 2, 4, 8, 16, 32, 64, 128, 256, and the defined weight values 93 of the eight groups of the other bits 0 of the bits 91 are respectively: 1, 1, 1, 1, 1, 1), at which time the individual weight values 100 of the 8 10-bit display data having less quantity of data converted from the 12-bit original gray scale data 60 are respectively 358, 358, 358, 358, 359, 359, 359, 358, which have a weight value sum 110 of 2867. Hence, the weight value sum 110 of the 8 10-bit display data having less quantity of data is identical to the weight value sum 64 of the 12-bit original gray scale data 60 (both being 2867). Accordingly, a raised refresh rate (refresh rate refers to the reciprocal of period (frequency), meaning of which is the completed number of cycles within a certain time) enables obtaining the identical original gray scale representation, and the complete gray scale is still completed within the original cycle, thus increasing the refresh rate of the high-bit portions (standard gray scale data) several fold, and enabling the present invention to use less quantity of data to achieve more gray scale numbers, as well as improve picture refresh rate effectiveness of the high bit portions and increase practicability.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A gray scale data bit allocation processing method within a light-emitting diode driving integrated circuit device, comprising the following steps:
1. Dividing original gray scale data into high-bit data and low-bit data within a light-emitting diode driving integrated circuit device;
2. Converting the low-bit data into multi-bit stack data having fewer bits;
3. Adding the high-bit data to the stack data to form display data;
4. Converting each of the original gray scale data into multiple display data having less quantity of data;
5. Displaying a picture using the display data with a higher refresh rate.

2. The gray scale data bit allocation processing method within a light-emitting diode driving integrated circuit device according to claim 1, wherein representative brightness weight values of each bit in the light-emitting diode driving integrated circuit device are already set, and are restored to a weight value sum of the original gray scale data by repeated renewing.
